(19) United States
(12) Patent Application Publication
(10) Pub. No.: US 2024/0109998 A1
(43) Pub. Date: Apr. 4, 2024

(54) POLYURETHANE ELASTOMER COMPOSITION COMPRISING LIGNIN

(71) Applicant: Evoco Limited, Toronto (CA)

(72) Inventors: Jason James Robinson, Toronto (CA); Rachele Nicole Carafa, Woodbridge (CA); Jinlei Li, Hamilton (CA); Guerino G. Sacripante, Oakville (CA)

(73) Assignee: Evoco Limited, Toronto (CA)

(21) Appl. No.: 17/958,266

(22) Filed: Sep. 30, 2022

(51) Int. Cl. C08G 18/08; C08G 18/12; C08G 18/20; C08G 18/32; C08G 18/42; C08G 18/64; C08H 7/00; C08J 9/00

(52) U.S. Cl. CPC C08G 18/14; C08G 18/12; C08G 18/2027; C08G 18/3206; C08G 18/4238; C08G 18/6492; C08H 6/00; C08J 9/0061; C08G 2101/00

(57) ABSTRACT

A polyurethane elastomer composition includes (a) an organic diisocyanate, (b) a polyester resin, (c) a chain extender, (d) a crosslinker, (e) a surfactant, (f) a foaming agent, (g) a plasticizer, and (h) an alkylated lignin.

### FIELD

The present invention relates generally to polyurethane and in particular, to a polyurethane elastomer composition comprising lignin.

### BACKGROUND

Polyurethanes are a large class of polymer used in a wide range of applications, such as construction, automotive, furniture, footwear, insulation, coatings, adhesives, elastomer foams, and consumer goods. Polyurethanes are produced from the polymerization reaction between polyols and/or aliphatic diols with diisocyanates. Additives are commonly added during the polymerization reaction to improve certain properties. Such additives include chain-extending agents, blowing agents, surfactants, fillers, plasticizers, pigments, additives, colorants and flame retardants. Blowing agents create a polyurethane foam, while surfactants control the bubble formation and, therefore, the cell formation of the foam. In general, fillers increase stiffness, plasticizers reduce hardness, and pigments add color to the material.

The main components of polyurethane, namely the polyols and the diisocyanates, are mainly derived from petrochemicals (namely, fossil fuels), and their production contributes heavily towards greenhouse gasses that negatively impact the environment. There is an overall need for polyurethane compositions for which the main components are based on renewable resource materials derived primarily from biomass, so that there is less dependency on fossil fuels.

Lignin, which represents up to 30% of lignocellulose biomass, is produced globally in amounts of about 50 million tons annually, mainly as a non-commercialized waste product. The majority of lignin is produced as a “black liquor” in the Kraft and sulfite pulping processes in the pulp and paper industry. Lignin is the second-most abundant renewable source of carbon, after cellulose, and is attracting interest for possible use as an alternative, sustainable material in polyurethane elastomers.

Use of lignin in polyurethane compositions has been described. For example, U.S. Patent Application Publication No. 2022/0195182 to Robinson et al. describes plasticizer lignin compositions for use in polyurethane elastomers generated from (a) an organic diisocyanate, (b) a polyester resin, (c) a chain extender, (d) a crosslinker, (e) a plasticizer lignin composition, optionally in the form of a dispersion, (f) a surfactant, (g) an optional blowing or foaming agent, (h) an optional bio-additive, (i) a catalyst, and (j) an optional colorant. Foams of the polyurethane elastomers can be selected for a number of articles, such as footwear, insoles, midsoles, shoes, boots, sneakers, slippers, clothing, insulation, automobile components, furniture components like coverings, bedding, seals, molded flexible parts, adhesives, automobiles, medical devices, and as a replacement for known polyurethane elastomers. polyurethane elastomer compositions that can be for example, selected, for footwear, insoles, middle soles, and similar articles. The content of U.S. Patent Application Publication No. 2022/0195182 is herein incorporated by reference in its entirety.

U.S. Pat. No. 10,604,616 to Phanopoulos et al. generally describes a polyurethane composite with a lignin dispersed in an aromatic poly-isocyanate. By dispersing the lignin in the isocyanate resin, the lignin partially reacts with the isocyanate and is incorporated into its network.

U.S. Pat. No. 10,745,513 to Kurple generally describes a thermoset plastic prepared by thermosetting a flame-resistant lignin polyol blend that includes a cross-linker, a chain extender, sugar, a polyol, and a solvent, where the flame-resistant lignin polyol blend further includes a flame retardant, that forms a complex with the lignin.

U.S. Pat. No. 10,604,615 to Moon et al. generally describes a rigid polyurethane foam which is the polymerization product of a composition including a concentrated acid, hydrolytic lignin, a polyol, and an isocyanate.

U.S. Pat. No. 9,598,529 to Langlois et al. generally describes a process for production of lignin based polyurethane products, where at least one dried lignin and one dried isocyanate are mixed to form a lignin-isocyanate mixture. The mixture is then heated and mixed with at least one polyol and at least one catalyst.

U.S. Pat. No. 10,087,298 to Chuang et al. generally describes a bio-polyol composition and a bio-polyurethane foam material. Using a modifier and a dispersing and grinding process, a modified lignin uniformly dispersed in the polyol solution can be formed.

U.S. Pat. No. 10,196,478 to Grunbauer et al. generally describes a dispersion composition that includes one or more dispersants, and an alkoxylated lignin. The dispersants can include a polyol diethylene glycol, tetraethylene glycol, propoxylated glycerol, ethoxylated pentaerythritol, diethlene glycol, and mixtures thereof.

U.S. Pat. No. 8,053,566 to Belanger et al. generally describes a method for isolating a lignin from a plant material by contacting the plant material with an aqueous ethanol solution at an elevated temperature and an elevated pressure for a retention time sufficient to produce a liquid solvent mixture of ethanol, ethanol-soluble lignin and water, and a plant pulp material; separating the plant pulp material from the liquid solvent mixture; precipitating the ethanol-soluble lignin and forming lignin particulates by diluting the liquid solvent mixture with an aqueous gasified solution containing dissolved gas under conditions that promote the formation of gas bubbles, whereby the gas bubbles attach to the precipitated lignin particulates as they form, and the precipitated lignin particulates are transported to the liquid surface by attachment to the gas bubbles; harvesting the precipitated lignin from the liquid surface; and recovering an isolated lignin component from the precipitated lignin.

U.S. Pat. No. 10,563,005 to Luo generally describes a process for preparation of aromatic polyester polyols containing lignin as a major reactant.

U.S. Pat. Nos. 4,292,214, 9,598,529, 10,087,298, and 10,323,115 relate to obtaining lignin functionality by mixing isocyanate and lignin, by adding lignin into a polyol, by mixing a lignin with a polyol prior to isocyanate injection, or by using a copolymer forming polyol. However, the resulting products that include lignin have a number of disadvantages, such as inferior mechanical properties, color and/or appearance.

Structurally, lignin is an amorphous dendritic network polymer comprising different aromatic phenylpropanoids units, attached through both ether and carbon-carbon linkages, and comprising alkanol and phenoxy groups. Lignin is intractable and poorly soluble in polyurethane-derived components such as polyols, diisocyanates and plasticizers.

Thus, because lignins usually have poor solubility in polyurethanes they are typically incorporated as particles or directly into the polyol or polyisocyanate, as illustrated in at least some of the above-identified prior art. Also, unfortunately, all lignin components are believed to be highly colored and have a brown to black appearance and thus are not that useful for flexible foam applications wherein low color is desired.

Improvements are generally desired. Accordingly, it is an object at least to provide a novel polyurethane elastomer composition comprising lignin.

### SUMMARY

There is a need for compositions and processes for flexible polyurethane elastomer foams with improved characteristics, and that include as a component a biobased polyol polyester, biobased plasticizer, biobased diisocyanates and biobased additives that are molecularly dispersed (soluble) such as alkylated lignin.

There is also a need for polyurethane elastomer foams comprising surfactants, plasticizers, dyes, crosslinkers, chain extenders, and at least one soluble lignin derivative such as alkylated lignin.

There is still also a need for including certain biobased additives like the alkylated lignin compositions disclosed herein into polyurethane elastomer foams to maintain and improve their performance, whereby adding these additives will not adversely affect the resulting foam properties. Lignin, which is for example, a polyol biopolymer, can be obtained through food-grade and non-food grade biomasses, including agricultural waste or biomass from forests or plants thereof.

There is a further need to reduce elastomer additive costs by replacing synthetic fillers such as glass fiber, carbon fiber, and other microplastics with the alkylated lignin compositions disclosed herein, given that lignin is a complex, high molecular weight polymer that occurs naturally in plant materials and is one of the most abundant renewable raw materials available. Moreover, large quantities of lignin are produced as by-products of the pulp and paper industry.

Still further, there is a need to decrease lignin reactivity, such that it does not intervene in the polymerization of a polyol and diisocyanate, to form the polyurethane elastomers.

Another need resides in generating polyurethane flexible foams that include biobased lignin containing compositions for enhancing or modifying the mechanical properties of the foams while simultaneously increasing the bio-content thereof.

Still another important need resides in providing polyurethane elastomer foams with a bio-content of, for example, from about 50 to about 90%, from about 40 to 80%, from about 70 to about 85%, and from about 60 to about 80%.

To address at least these needs, the present invention relates to the derivatization of lignin to an alkylated lignin, wherein the alkanol and phenoxy moieties of lignin are esterified to an alkylated lignin such as acetylated, or butylated lignin derivative with more hydrophobic characteristics and greater solubility in polyurethane derived components such as polyol, diisocyanate and plasticizer.

Thus, the following is directed to biobased polyurethane elastomer compositions that comprise alkylated lignin and that can be used in articles such as mattresses, upholstery, cushions, footwear, mats, pillows, medical devices, automotive seats and upholstery components. Specifically, polyurethane elastomer foam compositions can be generated from the reaction of polyester resin (or “polyol”), an organic diisocyanate, a chain extender, a crosslinker, a plasticizer, a surfactant, a foaming agent, optionally a colorant, optionally an additive, and an alkylated lignin. Methods of preparation of the polyurethane elastomer compositions are also described.

Also described is an alkylated lignin obtained from the reaction of lignin and an organic anhydride such as acetic anhydride, propionic anhydride and butyric anhydride, in the presence of an acid catalyst.

Further described is a process for preparation of a polyurethane elastomer, comprising mixing (a) an organic diisocyanate, (b) a polyester resin, (c) a chain extender, (d) a crosslinker, (e) a plasticizer, (f) a surfactant, (g) a foaming agent, (i) a colorant, and an optional catalyst; and (j) an alkylated lignin.

There is also described a polyurethane elastomer foam composition comprising from about 40 to about 55% by weight of a polyester resin, from about 1 to about 3% by weight of a chain extender, from about 1 to about 7% by weight of a crosslinker, from about 8 to about 15% by weight of a plasticizer, from about 0.2 to about 0.5% by weight of a surfactant, from about 0.5 to about 3% by weight of a chain extender, from about 0.1 to about 0.5% by weight of a catalyst, and from about 1 to about 10% by weight of an alkylated lignin, with from about 10 to about 25% by weight of an organic diisocyanate, where the total of the percentages by weight equals 100% by weight.

The polyurethane elastomers can be prepared from (i) a first mixture comprising a polyester resin, plasticizer, surfactant, chain extender, crosslinker, catalyst, water, alkylated lignin, and colorant; and contacting this mixture with a diisocyanate.

In embodiments, the polyurethane elastomers can be prepared using a multistage process, in which: A) one or more substantially linear polyester diols with a functionality of from about 1.8 to about 2.2 are reacted with a portion 1, such as one part of an organic diisocyanate or of a plurality of organic diisocyanates in a molar NCO/OH ratio of from 1.1:1 to 3.5:1, and from about 1.3:1 to about 2.5:1 to provide a relatively high molecular weight isocyanate-terminated prepolymer (“NCO prepolymer”); B) the prepolymer obtained in stage A) is blended with a portion 2 of the organic diisocyanate or the plurality of organic diisocyanates where the entirety of portion 1 and portion 2 corresponds to the entire amount of diisocyanates used; C) the mixture obtained in stage B) is reacted with one or more diol chain extenders with, for example, weight average molecular weights, as determined by GPC, of from about 60 to about 350 where the molar NCO:OH ratio resulting from the components used in A), B), and C) is at from about 0.9:1 to about 1.1:1, where the substantially linear polyester diols A) are comprised of succinic acid and 1,3-propanediol, and have an optional average molar mass of from about 750 to about 3,500 gram/mol. Thereafter, the alkylated lignin, and other components disclosed herein, can be added thereto.

### EMBODIMENTS

### Polyester (Polyol) Resins

The disclosed polyester resins can be amorphous or semi-crystalline and can be prepared by a polycondensation process by reacting suitable organic diols and suitable organic diacids in the presence of polycondensation catalysts. Generally, a stoichiometric equimolar ratio of organic diol and organic diacid is utilized, however, an excess of organic diol can be selected such that the resulting polymer displays a hydroxyl number of from about 30 to about 40, an acid number of less than about 5 milligrams/gram of KOH, preferably less than about 3 milligrams/gram of KOH, and more preferably less than about 1 milligrams/gram of KOH, and with a molecular weight average of from about 1,500 to about 5,000 Daltons as determined by GPC. In some instances, where the boiling point of the organic diol is from, for example, about 180 to about 230° C. (degrees Centigrade are hereafter used throughout), an excess amount of diol, such as an alkylene glycol (such as ethylene glycol or propylene glycol) of from about 0.2 to 1 mole equivalent, can be utilized and removed during the polycondensation process by distillation. The amount of catalyst utilized varies, and can be selected in amounts as disclosed herein, and more specifically, for example, from about 0.01 to about 1% by weight, or from about 0.1 to about 0.75% by weight based on weight of the polyester resin.

As used herein, “semi-crystalline” generally refers to a polymer having a highly ordered molecular structure and having a generally sharply defined melting point. These polymers also have some degree of amorphous regions where the chains are disordered, while crystalline polymers have a higher degree of long-range order in a polymer material, which in turn makes crystalline polymers very rigid with a higher melting point than their semi-crystalline counterpart. Amorphous polymers generally do not have a defined melting point and instead have a glass transition temperature.

Examples of organic diacids or diesters that can be used for preparation of the amorphous polyester resins and the semi-crystalline polyester resins are fumaric acid, maleic acid, oxalic acid, succinic acid, fumaric acid, itaconic acid, glutaric acid, adipic acid, suberic acid, azelaic acid, sebacic acid, 1,12-dodecane dioic acid, C-18 dimer acids, such as 1,16-octadecanedioic acid, phthalic acid, isophthalic acid, terephthalic acid, naphthalene-2,6-dicarboxylic acid, naphathalene-2,7-dicarboxylic acid, cyclohexane dicarboxylic acid, malonic acid and mesaconic acid, and diesters or anhydrides thereof. The organic diacid is selected in an amount of, for example, from about 45 to about 50% by weight of the polyester resin. The organic diacid selected can also be obtained from biomasses generated through a fermentation process, natural sources, and/or chemically derived from natural sources, and can be, for example, such as succinic acid, fumaric acid, itaconic acid, sebacic acid 1,12-dodecanedioic acid, 2,5-furandicarboxylic acid, azelaic acid, dimer acids, which include aliphatic dimer acids with from about 2 carbon atoms to about 36 carbon atoms, such as C-18 dimer acids, or dimerized fatty acids of dicarboxylic acids prepared by dimerizing unsaturated fatty acids obtained from tall oil, usually on clay catalysts; hydrogenated/saturated dimer acids; and other known suitable organic acids.

The organic diol selected can be obtained from biomasses generated through a fermentation process, natural sources, and/or chemically derived from natural sources, and can be, for example, 1,5-pentanediol, 1,2-propanediol (1,2-propylene glycol), 1,3-propanediol, 1,4-butanediol, 1,10-decanediol, 1,9-nonanediol, dimer diols, which include aliphatic dimer diols with from about 2 carbon atoms to about 36 carbon atoms, such as PRIPOL® and aliphatic diol reactant examples with, for example, from about 2 to about 36 carbon atoms, such as 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 2-ethyl-2-butyl-1,3-propanediol, alkylene glycols such as ethylene glycol, propylene glycol, monoethylene glycol, diethylene glycol, monopropylene glycol, dipropylene glycol, isosorbide, mixtures thereof, and the like. The organic diol may be present, for example, in an amount of from about 50 to about 60% by weight of the polyester resin.

In some embodiments, examples of specific dimer diols and dimer diacids providing enhanced hydrophobic characteristics, and thus excellent hydrolytically stable characteristics for the polyester resins, include dimer acids such as PRIPOL® 1013, PRIPOL® 1017, PRIPOL® 1009, and PRIPOL® 1012, and dimer diols such as PRIPOL® 2033, and PRIPOL® 2043.

Examples of semi-crystalline polyester resins, amorphous polyester resins, and mixtures thereof, and in some instances where the semi-crystalline polyester resins can be converted to amorphous polyester resins by altering the amount of amorphous polyester comonomers in the reaction mixture, include semi-crystalline polyester resins with, for example, a melting point range of equal to or less than, for example, about 50° C., such as from about 25 to about 49° C., and include those resins derived from straight chain aliphatic organic diacids, such as succinic acid, glutaric acid, adipic acid, suberic acid, azelaic acid, sebacic acid, 1,12-dodecane dioic acid, and straight chain aliphatic organic diols, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, and 1,12-dodecanediol, include polyesters containing poly(1,2-ethylene-succinate), poly(1,2-ethylene-adipate), poly(1,2-ethylene-sebacate), poly(1,2-ethylene-decanoate), poly(1,2-ethylene-nonoate), poly(1,2-ethylene-dodeanoate), poly(1,2-ethylene-azeleoate), poly(1,3-propylene-succinate), poly(1,3-propylene-adipate), poly(1,3-propylene-sebacate), poly(1,3-propylene-decanoate), poly(1,3-propylene-nonoate), poly(1,3-propylene-dodeanoate), poly(1,3-propylene-azeleoate), poly(1,4-butylene-succinate), poly(1,4-butylene-adipate), poly(1,4-butylene-sebacate), poly(1,4-butylene-decanoate), poly(1,4-butylene-nonoate), poly(1,4-butylene-dodeanoate), poly(1,4-butylene-azeleoate), poly(1,6-hexylene-succinate), poly(1,6-hexylene-adipate), poly(1,6-hexylene-sebacate), poly(1,6-hexylene-decanoate), poly(1,6-hexylene-nonoate), poly(1,6-hexylene-dodeanoate), poly(1,6-hexylene-azeleoate), poly(1,8-octylene-succinate), poly(1,8-octylene-adipate), poly(1,8-octylene-sebacate), poly(1,8-octylene-decanoate), poly(1,8-octylene-nonoate), poly(1,8-octylene-dodeanoate), poly(1,8-octylene-azeleoate), poly(1,9-nonylene-succinate), poly(1,9-nonylene-adipate), poly(1,9-nonylene-sebacate), poly(1,9-nonylene-decanoate), poly(1,9-nonylene-nonoate), poly(1,9-nonylene-dodeanoate), poly(1,9-nonylene-azeleoate), poly(1,10-decylene-succinate), poly(1,10-decylene-adipate), poly(1,10-decylene-sebacate), poly(1,10-decylene-decanoate), poly(1,10-decylene-nonoate), poly(1,10-decylene-dodeanoate), poly(1,10-decylene-azeleoate), mixtures thereof, other suitable known suitable components, and the like.

The semi-crystalline polyester resins with melting points as disclosed herein, such as from about 40 to about 50° C., and preferably from about 45 to about 49° C., can be prepared from a mixture of at least one straight chain aliphatic organic diacid, at least one straight chain aliphatic diol, and a branched aliphatic diol, such as 1,2-propanediol, 1,3-butanediol, 2,3-butanediol, 3,3-dimethyl pentanediol; 1,5-pentanediol, mixtures thereof, and the like. The at least one straight chain aliphatic organic diacid may be present in an amount of, for example, from about 45 to about 50% by weight of the polyester resin. The straight chain aliphatic diol may be present in an amount of, for example, from about 20 to about 40% by weight of the polyester resin, and the branched aliphatic diol may be present in an amount of, for example, from about 20 to about 40% by weight of the polyester resin. The polyester resins obtained can include copoly(1,3-propylene-succinate)-copoly(1,2-proplyene-succinate), copoly(1,4-butylene-succinate)-copoly(1,2-proplyene-succinate), copoly(1,3-propylene-sebacate)-copoly(1,2-proplyene-sebacate), copoly(1,3-propylene-dodecanoate)-copoly(1,2-proplyene-dodecanoate), copoly(1,3-propylene-azeleoate)-copoly(1,2-proplyene-azeleoate), and the like, and mixtures thereof.

The amorphous polyester resins selected for preparation of the polyurethane elastomers usually do not possess a melting point and can have a glass transition temperature of, for example, from about −25 to about 10° C., and can be prepared from a mixture of, at least, one or more straight chain aliphatic diacids, branched aliphatic diols, and optionally one or more straight chain aliphatic diols. The straight chain aliphatic diol may be present in an amount of, for example, from about 45 to about 50% by weight of the polyester resin, and the branched aliphatic diol may be present in an amount of, for example, from about 30 to about 55% by weight of the polyester resin. The optional one or more straight chain aliphatic diols may be present in an amount of, for example, from about 0 to about 20% by weight of the polyester resin. The polyester resins obtained can include copoly(1,2-propylene-succinate)-copoly(1,2-proplyene-sebacate), copoly(1,2-propylene-succinate)-copoly(1,2-proplyene-dodecanoate), copoly(1,2-propylene-sebacate)-copoly(1,2-proplyene-dodecanoate), copoly(1,2-propylene-dodecanoate)-copoly(1,2-proplyene-azeloate), copoly(1,2-propylene-azeleoate)-copoly(1,2-proplyene-succinate), poly(butylene-succinate), poly(butylene-2,5-furanate), poly(butylene-itaconate), poly(propylene-succinate), poly(propylene-2,5-furanate), poly(propylene-itaconate), and the like, and mixtures thereof.

The amorphous polyester resins, the semi-crystalline polyester resins, and mixtures thereof, can be present in the polyurethane elastomer in amounts of, for example, from about 1 to about 99% by weight, from about 10 to about 85% by weight, from about 18 to about 75% by weight, from about 25 to about 65% by weight, from about 30 to about 60% by weight, or from about 40 to about 55% by weight, based on the weight of the polyurethane elastomer.

### Catalysts

Examples of polycondensation catalysts that can be used for preparation of the above polyester resins are tetraalkyl titanates, dialkyltin oxide such as dibutyltin oxide, tetraalkyltin such as dibutyltin dilaurate, dialkyltin oxide hydroxide such as butyltin oxide hydroxide, aluminum alkoxides, alkyl zinc, dialkyl zinc, zinc oxide, stannous oxide, zinc acetate, titanium (iv) isopropoxide (Tyzor TE), tertiary amines, such as triethylamine, dimethylcyclohexylamine, N-methylmorpholine, N,N′-dimethylpiperazine, 2-(dimethylaminoethoxy)ethanol, diazabicyclo[2.2.2]octane, DAPCO 33 LV (33% triethylenediamine dissolved in 67% dipropylene glycol), BICAT 8109 (bismuth neodecanoate), Jeffcat-Zf-54 (bis-(2-dimethylaminoethyl)ether in dipropylene glycol), KOSMOS® 75 MEG, and the like, organometallic compounds, such as titanic esters, iron compounds, tin compounds, such as tin diacetate, tin dioctoate, tin dilaurate, the dialkyl tin salts of aliphatic carboxylic acids like dibutyltin diacetate and dibutyltin dilaurate, other suitable catalysts, and the like. More specifically, examples of catalysts used include organometallic compounds like titanic esters, iron compounds, tin compounds, and other suitable known catalysts. Other catalysts can also be used, such as those described in U.S. Pat. No. 10,934,384 to Robinson et al., the entire content of which is herein incorporated by reference in its entirety.

The catalysts can be selected in amounts of, for example, from about 0.01 to about 5% by weight, from about 0.1 to about 0.8% by weight, and from about 0.2 to about 0.6% by weight, and other suitable percentages, based on the weight of the starting diacid or diester used to generate the polyester resin.

In some embodiments, the catalysts used for preparation of the polyester resins, which are in turn used for preparation of polyurethane elastomer foams, remain in the polyurethane elastomer or are otherwise retained therein. Thus, purification processes can advantageously be avoided for polyester synthesis, and products thereof, and for preparation of the polyurethane elastomer foams.

### Alkylated Lignins

The alkylated lignin is prepared by esterification of lignin with an organic anhydride or organic acid in the presence of an acidic catalyst. Examples of alkylated lignin that can be used are acetylated lignin, propylated lignin, butylated lignin, pentylated lignin, hexylated lignin, decylated lignin, dodecylated lignin, mixtures thereof, and the like. The alkylated lignin may be present in the polyurethane elastomer in an amount of, for example, from about 1 to about 30% by weight, and preferably from about 2 to about 25% by weight, based on the weight of the polyurethane elastomer.

As will be understood, the lignins enhance the bio-content of the polyurethane elastomers and polyurethane elastomer foams, and render them environmentally friendly while simultaneously preserving or improving their mechanical properties. The polyurethane elastomer foams may be used in various applications such as, for example, footwear insoles, footwear midsoles, yoga mats, seat cushions, mattresses, and the like.

Examples of lignins that can be used are alkali lignins, Kraft lignins, Klason lignins, hydrolytic lignins, enzymic mild acidolysis lignins, organosolv lignins, steam explosion lignins, milled wood lignins, lignin sulphones, lignin sulphates (lignosulphonates) including the salts thereof of Ca, Na, Mg, K and Black Liquor, other suitable known lignins, and mixtures thereof. The lignins may be present in amounts of, for example, from about 0.1 to about 10% by weight, preferably from about 0.3 to about 10% by weight, more preferably from about 0.3 to about 5% by weight, still more preferably from about 0.5 to about 5% by weight, or still other suitable weight percentages, such as from about 3 to about 8% by weight, or still others, based on the weight of the polyurethane elastomer.

Examples of organic anhydride that can be used are acetic anhydride, propanoic (propionic) anhydride, butyric anhydride, pentanoic anhydride, hexanoic anhydride, decanoic anhydride dodecanoic anhydride, mixtures thereof, and the like.

Examples of acidic catalysts that can be used are sulfuric acid, p-toluene sulfonic acid, phosphoric acid, and Lewis acids such as zinc chloride, aluminum chloride, iron chloride, boron trifluoride, boron trichloride, and the like.

In one example, the alkylated lignin can be prepared by contacting lignin with excess organic dianhydride, such as from about 3 to about 10 weight equivalent of lignin, with optional solvent, in the presence of a catalyst of from about 0.01 to about 0.02 weight equivalent of lignin, at a temperature of from about 80 to about 140° C. for a duration of from about 1 to about 6 hours, after which the excess organic anhydride and optional solvent is removed by distillation under reduced atmosphere.

### Plasticizers

Examples of plasticizer that can be used for preparation of the polyurethane elastomer are tributyl-citrate, CITROFOL® available from Jungbunzlauer, Hallstar IM 8830, an ester available from Hallstar, triethyl-citrate; trimethyl-citrate, adipates such as EDENOL® 650R available from Emery Olechemicals, tributyl citrate, alkyl aryl phthalates, alkyl benzyl phthalates, including butyl benzyl phthalate, alkyl benzyl phthalate, wherein the alkyl group has a carbon chain of from seven to nine carbon atoms, TEXANOL™, benzyl phthalate, (2,2,4-trimethyl-1,3-pentanediol-monobutyrate benzyl phthalate), alkylphenyl phthalate, symmetrical and unsymmetrical dialkyl phthalates, including diisononyl phthalate, diisodecyl phthalate, dioctyl phthalate, di-n-butyl phthalate, dioctyl phthalate, dihexyl phthalate, diheptyl phthalate, butyloctyl phthalate, linear dialkyl phthalate, wherein the alkyl groups are independently carbon chains having from about seven to about eleven carbon atoms, and butyl cyclohexyl phthalate; phosphate plasticizers, such as tris-(2-chloro-1-methylethyl)phosphate, tris-(alpha-chloroethyl)phosphate (TCEP), tris-(2,3-dichloro-1-propyl)phosphate, YOKE-V6 (tetrakis-(2-chloroethyl)dichloroisopentyldiphosphate), and the like; phosphate ester plasticizers, such as, for example, 2-ethylhexyl diphenyl phosphate, isodecyl diphenyl phosphate, mixed dodecyl and tetradecyl diphenyl phosphate, trioctyl phosphate, tributyl phosphate, butylphenyl diphenyl phosphate, and isopropylated triphenyl phosphate; and benzoate plasticizers, such as, for example, TEXANOL™ benzoate (which is 2,2,4-trim ethyl-1,3-pentanediol-monobutyrate benzoate), glycol benzoate, propylene glycol dibenzoate, dipropylene glycol is dibenzoate, and tripropylene glycol dibenzoates. The plasticizer can can be present in amounts of, for example, from about 1 to about 30% by weight, preferably from about 1 to about 20% by weight, more preferably from about 5 to about 15% by weight, and most preferably from about 10 to about 15% by weight, based on the weight of the polyurethane elastomer.

### Bio-Additives

Examples of optional bio-additives that can be used for preparation of the polyurethane elastomer are those disclosed in U.S. Patent Application Publication No. 2022/0073674 to Robinson et al., and can include chitin, Nutmeg, derived from its seed thereof and mace the seed covering, and chitosan (obtained from Tidal Vision), eggshells (obtained from Lady Gouldian Finch), hazelnut shells (obtained from Grimo Nut Nursery), walnut shells, peanut shells, Brazilian nutshells, pecan shells, cashew nutshells, almond shells, chestnut shells, macadamia nutshells, pistachio nutshells, pine nutshells, cellulose, and mixtures thereof. When present, the bio-additives can be present in amounts of, for example, from about 0.01 to about 10% by weight, preferably from about 0.5 to about 5% by weight, and more preferably from about 1 to about 4% by weight, based on the weight of the polyurethane elastomer.

The presence of at least one bio-additive increases the bio-content of the polyurethane composition, such that the bio-content of the polyurethane composition becomes from about 60 to about 90%, from about 40 to about 85%, from about 70 to about 85%, or from about 60 to about 80%.

### Crosslinkers

Examples of crosslinker that can be used for preparation of the polyurethane elastomer are diethanolamine, glycerol, trimethylol propane, pentaerythritol, 1,2,4-butanetriol, thioglycolic acid, 2,6-dihydroxybenzoic acid, melamine, diglycolamine, 1,2,6-hexanetriol, glycerol, 1,1,1-trimethylolethane, 1,1,1-trimethylolpropane (TMP), pentaerythritol, triisopropanol amine, triethanol amine, tartaric acid, citric acid, malic acid, trimesic acid, trimellitic acid, trimellitic anhydride, pyromellitic acid, and pyromellitic dianhydride; trimethylolpropane, trimethylolethane; pentaerythritol, polyethertriols, tartaric acid, citric acid, malic acid, trimesic acid, trimellitic acid, trimellitic anhydride, pyromellitic acid, and pyromellitic dianhydride; trimethylolpropane, trimethylolethane; pentaerythritol, polyethertriols, and glycerol, and especially polyols, such as trimethylolpropane, pentaerythritol, and biobased materials thereof. The crosslinker can be present in amounts of, for example, from about 0.1 to about 10% by weight, and preferably from about 0.1 to about 5% by weight, based on the weight of the polyurethane elastomer. Other known suitable crosslinkers can also be used.

### Chain Extenders

Examples of chain extender that can be used for preparation of the polyurethane elastomer are polyhydric alcohols, and carboxylic acid derivatives having two functional groups. More specifically, the chain extender can contain, for example, two hydroxyl moieties such as 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 2-ethyl-2-butyl 1,3-propanediol; alkylene glycols, such as ethylene glycol, propylene glycol, monoethylene glycol, diethylene glycol, monopropylene glycol, dipropylene glycol, mixtures thereof, other known suitable chain extenders, and the like. The chain extender can be present in amounts of, for example, from about 0.1 to about 10% by weight, and preferably from about 0.1 to about 5% by weight, based on the weight of the polyurethane elastomer. Other known suitable chain extenders can also be used.

### Surfactants

Examples of surfactant that can be used for preparation of the polyurethane elastomer are polyether-silicone oil mix (TEGOSTAB® B4113) available from Evonik, 8383, silicone surfactant DABCO DC® 193 or TEGOSTAB® B8383 available from Evonik, sodium dodecylbenzene sulfonate, sodium dodecylnaphthalene sulfate, dialkylbenzenealkyl, sulfates and sulfonates, adipic acid, NEOGEN R™ or NEOGEN SC™ available from Daiichi Kogyo Seiyaku, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy) ethanol, available from Rhodia as IGEPAL CA-210TH, IGEPAL CA-520TH, IGEPAL CA-720™, IGEPAL CO-890™, IGEPAL CO-720™, IGEPAL CO-290™, ANTAROX 890™, ANTAROX 897™, and other suitable known surfactants. The surfactant can be present in amounts of, for example, from about 0.1 to about 10% by weight, and preferably from about 0.1 to about 3% by weight, based on the weight of the polyurethane elastomer.

As used herein, TEGOSTAB® B4113 and B8383 are considered silicone surfactants; CA-210 is a surfactant of octylphenoxy poly(ethyleneoxy)ethanol; CA-520 is a polyoxyethylene (5) isooctylphenyl ether surfactant; ANTAROX® 890 is an olyoxyethylene (40) nonylphenyl ether surfactant; and ANTAROX® 897 is a poly(oxy-1,2-ethanediyl), α-(nonylphenyl)-ω-hydroxy surfactant.

### Colorants

Examples of colorant that can be used for preparation of the polyurethane elastomer are pigments, dyes, mixtures thereof, and the like. Examples of dyes and pigments include inorganic pigments, such as carbon black, whiteners, such as titanium oxide which has weather resistance, and organic pigments and dyes, such as phthalocyanine blue, azo dyes, Indigo, Congo Red, Methyl Orange, Malachile Green, purple dyes, brown dyes, black dyes, Pigment Blue 15:3 or C.I. Pigment Blue 15:4, phthalocyanine green, quinacridone red, indanthrene orange, and isoindolinone yellow, C.I. Pigment Red 254 and C.I. Pigment Red 122, C.I. Pigment Yellow 151 and C.I. Pigment Yellow 74, Fates Dye and Keen Dye available from BAO Shen Polyurethane Tech.LTD-China, and other suitable known colorants, such as known dyes and pigments illustrated in the Color Index (C.I.), such as known magenta, yellow, and cyan colorants. The colorants can be present in amounts of, for example, from about 0.1 to about 10% by weight, preferably from about 0.1 to about 5% by weight, and more preferably from about 0.1 to about 3% by weight, based on the weight of the polyurethane elastomer.

### Foaming Agents

There is selected as the foaming (or blowing) agent water and other suitable known blowing agents present in the reaction mixture and in the flexible polyurethane foams thereof, and which increases the firmness of the resulting foams. A soft, flexible, plasticized water-blown polyurethane foam composition can be produced from the reaction of a natural polyol and methylene diphenyl diisocyanate, (MDI) or an equivalent isocyanate, and by optionally adding a plasticizer.

Specific examples of foaming agents include water, compressed gases, such as CO₂, N₂, air or low boiling liquids like cyclopentane, pentane, isobutane and hydrofluorocarbons. The foaming agents may be added in amounts of from about 0.03 to about 10% by weight, and preferably from about 0.5 to about 3% by weight, based on the weight of the polyurethane elastomer. Also, for example, CO₂ may be generated in-situ by the decomposition of NaHCO₃ or the reaction of water with isocyanate.

### Organic Diisocyanates

Examples of organic diisocyanates that can be used for preparation of the polyurethane elastomer are aliphatic diisocyanates, such as hexamethylene diisocyanate, cycloaliphatic diisocyanates, such as isophorone diisocyanate, cyclohexane 1,4-diisocyanate, 1-methylcyclohexane 2,4-diisocyanate, and 1-methylcyclohexane 2,6-diisocyanate, and corresponding isomer mixtures, dicyclohexylmethane 4,4′-diisocyanate, dicyclohexylmethane 2,4′-diisocyanate, dicyclohexylmethane 2,2′-diisocyanate, and corresponding isomer mixtures, aromatic diisocyanates, such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate, and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates or diphenylmethane 2,4′-diisocyanates, 4,4′-diisocyanato-1,2-diphenylethane, and naphthylene 1,5-diisocyanate. Examples of especially selected diisocyanates are hexamethylene 1,6-diisocyanate, cyclohexane 1,4-diisocyanate, isophorone diisocyanate, dicyclohexylmethane diisocyanate, diphenylmethane diisocyanates with more than 96% by weight content of diphenylmethane 4,4′-diisocyanate, naphthylene 1,5-diisocyanate, other suitable known diisocyanates, and mixtures thereof.

In embodiments, there can be selected mixtures of a diisocyanate and a polyisocyanate that provides an improved thermoplastically processable polyurethane elastomer. The polyisocyanate mixture can be present in an amount of up to about 15% by weight, based on the total weight of the diisocyanates present, however, up to about 40% by weight of polyisocyanate can be used. Examples of polyisocyanates include triisocyanates, biurets and isocyanurate trimer. For example, triphenylmethane 4,4′,4″-triisocyanate and polyphenylpolymethylene polyisocyanates as well as hexamethylene diisocyanate (HDI) biuret trimer, isocyanurate trimer, and isophorone (IPDI) isocyanurate trimer.

### Polyurethane Characterization

The characteristics and properties of the polyurethane products can be measured, as illustrated in the Examples to follow, by known processes and devices. More specifically, there was selected, as tensile tester, the ADMET eXpert 7601 Tensile Tester to measure tensile strength, tensile elongation, and tear strengths. Tensile test samples of the polyurethane elastomer, and namely of the polyurethane elastomer foam, were prepared in dog-bone shapes using a die cutter. The samples had dimensions in accordance with one or more of ASTM D412, ASTM D3574-17, SATRA TM-2 standards. Each sample was placed between clamps of the tensile tester, and the appropriate force was applied to the sample at a particular rate to measure the characteristics and properties of the polyurethane elastomers.

Density was measured using the equation Density=Mass/Volume, where mass represents the mass of the material in a mold measured on an analytical balance. Volume of the mold was obtained from the dimensions of the mold. For example, if a mold produced “10 mm” polyurethane elastomer foam plaques having a length of 21 cm, a width of 14.8 cm, and a thickness of 1 cm, then the volume was calculated to be 21×14.8×1=310.8 cm³.

The hardness of the polyurethane products can be measured on the Asker C scale, and can also be measured by a durometer.

### Bio-Content

The bio-content of the polyurethane elastomer foams can be determined by various methods. In one method, the bio-content can be measured as follows where, for example, the lignin composition, the polyester resin, the plasticizer, the optional bio-additive, and the chain extender all contribute bio-content to the polyurethane elastomer foams.

Add the total weight of all the components/ingredients=X grams

Add the weight of the components/ingredients that are biobased, which in this example are the lignin composition, plus the polyester resin, plus the plasticizer, plus the optional bio-additive, plus the chain extender=Y grams

Total bio-content (in %)=(Y/X)×100

The bio-content for the polyurethane elastomer may be, for example, from about 60 to about 90%, from about 40 to about 85%, from about 70 to about 85%, and from about 60 to about 80%.

Generally, in some embodiments of polyurethane elastomer preparation, and in the relevant Examples that follow, the active reactant components (such as the polyester resin, the crosslinker, the chain extender, and the foaming agent) and the non-reactive components (such as the lignin, the plasticizer, the colorant, the plasticizer, and the surfactant) are initially admixed, followed by the reaction addition of the organic diisocyanate and heating.

Subsequently, in some embodiments, and although it is not desired to be limited by theory, the polyester resin, which contains at least one hydroxyl end group (namely, the polyester polyol) reacts with the diisocyanate, resulting in urethane linkages. The chain extender of, for example, 1,3-propanediol which also has hydroxyl ends also reacts with the diisocyanate to generate urethane linkages. The crosslinker of, for example, diethanol amine, which includes two hydroxyl moieties and one amine (N—H) moiety, has functionalities (in this case, 3 functionalities) which all react with the diisocyanate to form either the urethane linkage or the urea linkage, respectively. Finally, the foaming agent, such as water, reacts with the diisocyanate to result in an amine, and that amine further reacts with the diisocyanate to give the urea linkage. The elastomer foam can be referred to as a polyurethane, however it is known and accepted that when a crosslinker, such as diethanolamine, and a foaming agent, such as water, are present there will be generated some urea linkages, albeit in very small amounts, such as less than about 3.5%.

Turning now to the Examples, specific embodiments of the present disclosure as illustrated in the following Examples are for illustrative purposes and are not limited to the materials, conditions, or process parameters set forth in these embodiments. Parts and percentages are by weight unless otherwise indicated. It will be understood that components can be mixed in various sequences to obtain the polyurethane elastomers and the polyurethane elastomer foams, which can be biodegradable.

Unless specifically recited in a claim, steps, or components of claims should not be implied, or imported from the specification, or any other claims as to any particular order, number, position, size, shape, angle, color, or material. % by weight or weight % is a known quantity, and is usually based on the total of the components present divided by the specific component present.

In the Examples that follow, Kraft lignin received from West Fraser Mills ltd was used as the raw material for preparing the acetylated lignin and butylated lignin. The received Kraft lignin has a moisture content of 38 wt % and was dried at 75° C. for 2 days before being used for the synthesis as the “dried lignin”. Acetic anhydride (synthesis grade) and 98% butyric anhydride are from Sigma Aldrich, Canada. Sodium bicarbonate (Reagent grade) is from Bioshop, Canada.

Additionally, in the Examples that follow, hardness was measured using a Checkline (AD-100-ASK-C) Asker C durometer at loads of 1 kg and 2.4 kg, in accordance with the ASTM D2240 standard. Rebound was measured according to the ASTM D2632 and D3572 standards. Dog-bone samples (gauge dimension: 80 mm length×12 mm width×10 mm thickness) were cut from the plaque for tensile testing. The tensile testing was carried out in accordance with ASTM D3574, and used a crosshead speed of 500 mm/min. Die C and split tear strengths were tested in accordance with ASTM D624 and SATRA TM65 standards, respectively, and used a crosshead speed of 500 mm/min.

### EXAMPLE 1

### Preparation of Acetylated Lignin

To a 3-necked round bottom flask was added 65 grams of acetic anhydride, which was then heated in an oil bath at 80° C. under nitrogen. To this was added 20 grams of dried lignin. The mixture was stirred for 2 hours. The reaction product was then poured into a mixture of 120 grams of water and 125 grams of ethanol, after which the product precipitated. The mixture was allowed to cool to room temperature overnight, after which the upper liquid of the mixture was decanted and sedimented product was collected by vacuum filtration. The sedimented product was washed with water, then neutralized with a 0.1 M sodium bicarbonate solution, and washed again with water. The final product, acetylated lignin, was dried in an oven at 75° C. overnight.

### EXAMPLE 2

### Preparation of Butylated Lignin

To a 3-necked round bottom flask was added 100 grams of butyric anhydride, which was then heated in an oil bath at 80° C. under nitrogen. To this was added 20 grams of dried lignin. The mixture was stirred for 2 hours. The reaction product was then poured into 250 grams water, after which the product precipitated. The mixture was allowed to cool to room temperature overnight, after which the upper liquid of the mixture was decanted and sedimented product was collected by vacuum filtration. The sedimented product was washed with water, then neutralized with 0.1 M sodium bicarbonate solution, and washed again with water. The final product, butylated lignin, was dried in an oven at 75° C. overnight.

### EXAMPLE 3

Preparation of Polyurethane Elastomer Foam Derived from 0.5 Weight % of Acetylated Lignin

To a 500 mL container were added 0.8 grams of the acetylated lignin of Example 1, and 30 grams of tributyl citrate as plasticizer (available from Jungbunzlauer as CITROFOL®). The mixture was heated to 75° C. and held at this temperature for 30 minutes. The mixture, which contained dissolved acetylated lignin in tributyl citrate, was then cooled to room temperature, and to this was added 100 grams of a polyester, derived from succinic acid and 1,3-propanediol (available as PS3000 from Panolam Industries), which had been melted in an oven at 70° C. To this mixture were added 0.5 grams of TEGOSTAB® surfactant (available from Evonik), 0.5 grams of 1,3 propanediol (chain extender), 0.8 grams of DABCO LV® catalyst (available from Evonik), and 0.75 gram of water, followed by mixing for 3 minutes using a homogenizer at 1800 rpm. 26.7 Grams of diphenylmethane diisocyanate (available from Huntsman as Rubinate™ 1680) was then injected via a syringe, and the mixture was homogenized for a further 10 seconds. 125 grams of this mixture was then poured into a plaque mold that had a volume of 311 cm³ (21 cm length×18.8 width×1 cm depth) and that was kept at a temperature of 50 to 55° C. The mixture was allowed to cure in the mold for 30 minutes, yielding a polyurethane elastomer foam having a plaque density of about 0.4 g/cm³. The properties of the polyurethane elastomer foam are listed in Table 1.

### EXAMPLE 4

Preparation of Polyurethane Elastomer Foam Derived from 0.5 Weight % of Butylated Lignin

To a 500 mL container were added 0.8 grams of the butylated lignin of Example 2, and 30 grams of tributyl citrate as plasticizer (available from Jungbunzlauer as CITROFOL®). The mixture was heated to 75° C. and held at this temperature for 30 minutes. The mixture, which contained dissolved butylated lignin in tributyl citrate, was then cooled to room temperature, and to this was added 100 grams of a polyester, derived from succinic acid and 1,3-propanediol (available as PS3000 from Panolam Industries), which had been melted in an oven at 70° C. To this mixture were added 0.5 grams of TEGOSTAB® surfactant (available from Evonik), 0.5 grams of 1,3 propanediol (chain extender), 0.8 grams of DABCO LV® catalyst (available from Evonik), and 0.75 gram of water, followed by mixing for 3 minutes using a homogenizer at 1800 rpm. 26.7 Grams of diphenylmethane diisocyanate (available from Huntsman as Rubinate™ 1680) was then injected via a syringe, and the mixture was homogenized for a further 10 seconds. 125 grams of this mixture was then poured into the plaque mold having the volume of 311 cm³ and kept at a temperature of 50 to 55° C. The mixture was allowed to cure in the mold for 30 minutes, yielding a polyurethane elastomer foam having a plaque density of about 0.4 g/cm³. The properties of the polyurethane elastomer foam are listed in Table 1.

### EXAMPLE 5

Preparation of Polyurethane Elastomer Foam Derived from 1 Weight % of Butylated Lignin

To a 500 mL container were added 1.6 grams of the butylated lignin of Example 2, and 30 grams of tributyl citrate as plasticizer (available from Jungbunzlauer as CITROFOL®). The mixture was heated to 75° C. and held at this temperature for 30 minutes. The mixture, which contained dissolved butylated lignin in tributyl citrate, was then cooled to room temperature, and to this was added 100 grams of a polyester, derived from succinic acid and 1,3-propanediol (available as PS3000 from Panolam Industries), which had been melted in an oven at 70° C. To this mixture were added 0.5 grams of TEGOSTAB® surfactant (available from Evonik), 0.5 grams of 1,3 propanediol (chain extender), 0.8 grams of DABCO LV® catalyst (available from Evonik), and 1.06 gram of water, followed by mixing for 3 minutes using a homogenizer at 1800 rpm. 26.7 Grams of diphenylmethane diisocyanate (available from Huntsman as Rubinate™ 1680) was then injected via a syringe, and the mixture was homogenized for a further 10 seconds. 125 grams of this mixture was then poured into the plaque mold having the volume of 311 cm³ and kept at a temperature of 50 to 55° C. The mixture was allowed to cure in the mold for 30 minutes, yielding a polyurethane elastomer foam having a plaque density of about 0.4 g/cm³. The properties of the polyurethane elastomer foam are listed in Table 1.

### EXAMPLE 6

Preparation of Polyurethane Elastomer Foam Derived from 2 Weight % of Butylated Lignin

To a 500 mL container were added 3.2 grams of the butylated lignin of Example 2, and 30 grams of tributyl citrate as plasticizer (available from Jungbunzlauer as CITROFOL®). The mixture was heated to 75° C. and held at this temperature for 30 minutes. The mixture, which contained dissolved butylated lignin in tributyl citrate, was then cooled to room temperature, and to this was added 100 grams of a polyester, derived from succinic acid and 1,3-propanediol (available as PS3000 from Panolam Industries), which had been melted in an oven at 70° C. To this mixture were added 0.5 grams of TEGOSTAB® surfactant (available from Evonik), 0.5 grams of 1,3 propanediol (chain extender), 0.8 grams of DABCO LV® catalyst (available from Evonik), and 1.06 gram of water, followed by mixing for 3 minutes using a homogenizer at 1800 rpm. 26.7 Grams of diphenylmethane diisocyanate (available from Huntsman as Rubinate™ 1680) was then injected via a syringe, and the mixture was homogenized for a further 10 seconds. 125 grams of this mixture was then poured into the plaque mold having the volume of 311 cm³ and kept at a temperature of 50 to 55° C. The mixture was allowed to cure in the mold for 30 minutes, yielding a polyurethane elastomer foam having a plaque density of about 0.30 g/cm³. The properties of the polyurethane elastomer foam are listed in Table 1.

### EXAMPLE 7

Preparation of Polyurethane Elastomer Foam Derived from 5 Weight % of Butylated Lignin

To a 500 mL container were added 8.7 grams of the butylated lignin of Example 2, and 30 grams of tributyl citrate as plasticizer (available from Jungbunzlauer as CITROFOL®). The mixture was heated to 75° C. and held at this temperature for 30 minutes. The mixture, which contained dissolved butylated lignin in tributyl citrate, was then cooled to room temperature, and to this was added 100 grams of a polyester, derived from succinic acid and 1,3-propanediol (available as PS3000 from Panolam Industries), which had been melted in an oven at 70° C. To this mixture were added 0.5 grams of TEGOSTAB® surfactant (available from Evonik), 0.5 grams of 1,3 propanediol (chain extender), 1.2 grams of DABCO LV® catalyst (available from Evonik), and 1.06 grams of water, followed by mixing for 3 minutes using a homogenizer at 1800 rpm. 26.7 Grams of diphenylmethane diisocyanate (available from Huntsman as Rubinate™ 1680) was then injected via a syringe, and the mixture was homogenized for a further 10 seconds. 125 grams of this mixture was then poured into the plaque mold having the volume of 311 cm³ and kept at a temperature of 50 to 55° C. The mixture was allowed to cure in the mold for 30 minutes, yielding a polyurethane elastomer foam having a plaque density of about 0.4 g/cm³. The properties of the polyurethane elastomer foam are listed in Table 1.

### EXAMPLE 8

Preparation of Polyurethane Elastomer Foam Derived from 7.5 Weight % of Butylated Lignin

To a 500 mL container were added 13 grams of the butylated lignin of Example 2, and 30 grams of tributyl citrate as plasticizer (available from Jungbunzlauer as CITROFOL®). The mixture was heated to 75° C. and held at this temperature for 30 minutes. The mixture, which contained dissolved butylated lignin in tributyl citrate, was then cooled to room temperature, and to this was added 100 grams of a polyester, derived from succinic acid and 1,3-propanediol (available as PS3000 from Panolam Industries), which had been melted in an oven at 70° C. To this mixture were added 0.5 grams of TEGOSTAB® surfactant (available from Evonik), 0.5 grams of 1,3 propanediol (chain extender), 1.2 grams of DABCO LV® catalyst (available from Evonik), and 1.06 grams of water, followed by mixing for 3 minutes using a homogenizer at 1800 rpm. 26.7 Grams of diphenylmethane diisocyanate (available from Huntsman as Rubinate™ 1680) was then injected via a syringe, and the mixture was homogenized for a further 10 seconds. 125 grams of this mixture was then poured into the plaque mold having the volume of 311 cm³ and kept at a temperature of 50 to 55° C. The mixture was allowed to cure in the mold for 30 minutes, yielding a polyurethane elastomer foam having a plaque density of about 0.4 g/cm³. The properties of the polyurethane elastomer foam are listed in Table 1.

TABLE 1

| | Alkylated | | Rebound | Tensile | Tensile | Die C tear | | Bio- |
|---|---|---|---|---|---|---|---|---|
| | Lignin | Hardness | D2632/ | strength | elongation | strength | Split tear | content |
| Example | (%) | (1/2.4 kg) | D3572 | (Kg/cm²) | (%) | (N/mm) | (N/mm) | (%) |
| 3 | 0.5 | 21/23 | 42/47 | 12 | 573 | 6.4 | 1.6 | 78.6 |
| 4 | 0.5 | 21/24 | 40/43 | 12 | 563 | 6.3 | 1.3 | 78.6 |
| 5 | 1 | 21/26 | 47/49 | 11 | 551 | 5.6 | 1.3 | 78.7 |
| 6 | 2 | 21/25 | 33/34 | 10 | 581 | 6.0 | 1.5 | 78.9 |
| 7 | 5 | 23/25 | 43/50 | 11 | 464 | 5.1 | 1.3 | 79.3 |
| 8 | 7.5 | 25/27 | 38/43 | 8 | 367 | 6.1 | 1.60 | 79.8 |

The claims, as originally presented and as they may be amended, include alternatives, modifications, improvements, equivalents, and substantial equivalents of the disclosed embodiments and teachings, including those that are presently unforeseen, or unappreciated, and that, for example, may arise from applicants/patentees and others. Unless specifically recited in a claim, steps, or components of claims should not be implied, or imported from the specification, or any other claims as to any particular order, number, position, size, shape, angle, color, or material. Percent (%) by weight is a known quantity and is usually based on the total of the components present divided by the specific component present.

What is claimed is:

1. A polyurethane elastomer composition comprising (a) an organic diisocyanate, (b) a polyester resin, (c) a chain extender, (d) a crosslinker, (e) a surfactant, (f) a foaming agent, (g) a plasticizer, and (h) an alkylated lignin.

2. The polyurethane elastomer composition of claim 1, wherein said alkylated lignin is at least one of acetylated lignin, propylated lignin, butylated lignin, pentylated lignin, hexylated lignin, decylated lignin, dodecylated lignin, and mixtures thereof, and wherein said alkylated lignin is present in an amount of from about 0.5 to about 30% by weight of the polyurethane elastomer.

3. The polyurethane elastomer composition of claim 1, wherein said alkylated lignin is derived from lignin, an organic anhydride and a catalyst.

4. The polyurethane elastomer composition of claim 3, wherein said lignin is at least one of a pal alkali lignin, a Kraft lignin, a Klason lignin, a hydrolytic lignin, an enzymic mild acidolysis lignin, an organosolv lignin, a steam explosion lignin, a milled wood lignin, a lignin sulphite, a lignin sulphate, lignosulphonates, and salts thereof containing at least one of Ca, Na, Mg, and K and Black Liquor.

5. The polyurethane elastomer composition of claim 3 wherein said organic anhydride is at least one of acetic anhydride, propanoic (propionic) anhydride, butyric anhydride, pentanoic anhydride, hexanoic anhydride, decanoic anhydride dodecanoic anhydride, and mixtures thereof.

6. The polyurethane elastomer composition of claim 3 wherein said catalyst is at least one of sulfuric acid, p-toluene sulfonic acid, phosphoric acid, and a Lewis acid comprising one or more of zinc chloride, aluminum chloride, iron chloride, boron trifluoride, and boron trichloride.

7. The polyurethane elastomer composition of claim 1, wherein said elastomer has a hardness value of from about 15 to about 60 Asker C, a tensile strength of from about 1 to about 10 MPa, a resilience of from about 25 to about 60%, an elongation at break of from about 150 to 700%, and a tear strength of from about 2 to about 4 N/mm².

8. The polyurethane elastomer composition of claim 1 wherein the bio-content of the polyurethane elastomer is from about 60 to about 90%.

9. The polyurethane elastomer composition of claim 1, further comprising a colorant.

10. The polyurethane elastomer composition of claim 9, wherein said colorant is at least one of a dye, a pigment, and mixtures thereof,
wherein said colorant is present in an amount of from about 0.5 to about 5% by weight of the polyurethane elastomer,
wherein said polyester resin is a semi-crystalline polyester resin that is at least one of poly(1,3-propylene-succinate), and copoly(1,3-propylene-succinate)-copoly(1,2-propylene-succinate), wherein the melting point of the semi-crystalline polyester resin is from about 25 to about 50° C., and
wherein said foaming agent is carbon dioxide or water.

11. The polyurethane elastomer composition of claim 1, wherein said polyester resin is a crystalline polyester resin generated from reaction of an organic diacid and an organic diol,
wherein said organic diacid is at least one of succinic acid, adipic acid, sebacic acid, 1,12-dodecanedioic acid, a dimer diacid, and polymerized fatty acids,
wherein said organic diol is at least one of 1,5-pentanediol, ethylene glycol, diethylene glycol, 1,3-propanediol, 1.2-propanediol, dipropylene glycol, 1,4-butanediol, 3-methyl-1,5-pentanediol, 1,6-hexanediol, 1,9-nonanediol, and a dimer diol, and
wherein said organic diol and said organic diacid are obtained from natural carbohydrates, biobased carbohydrates, or from fermentation of carbohydrates.

12. The polyurethane elastomer composition of claim 1, wherein said organic diisocyanate is at least one of diphenylmethane 4,4′-diisocyanate, isophorone diisocyanate, dicyclohexylmethane 4,4-diisocyanate, hexamethylene 1,6-diisocyanate, naphthalene 1,5-diisocyanate, and mixtures thereof.

13. The polyurethane elastomer composition of claim 1, wherein said organic diisocyanate is methylenediphenyl diisocyanate, and
wherein said polyester resin is a semi-crystalline polyester resin that is at least one of poly(1,3-propylene-succinate), and copoly(1,3-propylene-succinate)-copoly(1,2-propylene-succinate).

14. The polyurethane elastomer composition of claim 1, wherein said plasticizer is at least one of tributyl-citrate, an ester, triethyl-citrate; trimethyl-citrate, an adipate, an alkyl aryl phthalate, and an alkyl phthalate.

15. The polyurethane elastomer composition of claim 1, wherein said surfactant is at least one of a polyether-silicone oil, a silicone surfactant, sodium dodecylbenzene sulfonate, sodium dodecylnaphthalene sulfate, dialkyl benzenealkyl, adipic acid, polyvinyl alcohol, polyacrylic acid, methalose, methyl cellulose, and ethyl cellulose.

16. The polyurethane elastomer composition of claim 1, wherein said chain extender is at least one of an alkylene diol and an alkylene glycol,
wherein said polyester resin is a semi-crystalline polyester resin that is at least one of poly(1,3-propylene-succinate), and copoly(1,3-propylene-succinate)-copoly(1,2-propylene-succinate),
wherein said plasticizer is tributyl citrate,
wherein said crosslinker is an amine,
wherein said foaming agent is water or carbon dioxide, and
wherein the polyurethane elastomer further comprises a colorant comprising a dye.

17. The polyurethane elastomer composition of claim 16, wherein said lignin is a cross-linked phenolic polymer.

18. The polyurethane elastomer composition of claim 1 wherein said crosslinker is at least one of diethanolamine, glycerol, trimethylol propane, pentaerythritol, 1,2,4-butanetriol, thioglycolic acid, 2,6-dihydroxybenzoic acid, melamine, and mixtures thereof.

19. The polyurethane elastomer composition of claim 1, wherein said plasticizer is present in the polyurethane elastomer in an amount of from about 0.1 to about 30% by weight of the polyurethane elastomer.

20. A polyurethane elastomer formed by mixing and then reacting the components of the composition of claim 1.

21. The polyurethane elastomer of claim 20, wherein the polyurethane elastomer is a polyurethane elastomer foam.
